(19) United States
(12) Patent Application Publication
(10) Pub. No.: US 2017/0227115 A1
(43) Pub. Date: Aug. 10, 2017

(54) THREADED PLANETARY PIN

(71) Applicants: ZF FRIEDRICHSHAFEN AG, Friedrichshafen (DE); ZF WIND POWER ANTWERPEN N.V., Lommel (BE)

(72) Inventors: Warren SMOOK, Huldenberg (BE); Jo DE SMET, Puurs (BE); Roger BOGAERT, Dendermonde (BE)

(73) Assignees: ZF Friedrichshafen AG, Friedrichshafen (DE); ZF Wind Power Antwerpen N.V., Lommel (BE)

(21) Appl. No.: 15/327,718

(22) PCT Filed: Jun. 22, 2015
(86) PCT No.: PCT/EP2015/063891

§ 371 Date: Jan. 20, 2017

(30) Foreign Application Priority Data
Jul. 22, 2014 (DE) 10 2014 214 295.4

(51) Int. Cl. F16H 57/08; F16C 25/06; F16C 33/58; F16C 19/38

(52) U.S. Cl. CPC F16H 57/082; F16C 19/386; F16C 25/06; F16C 33/581; F16H 2057/085; F16C 2360/31; F16C 2361/61

(57) ABSTRACT

An arrangement for use, in particular, in the transmission of a wind turbine, having a planet carrier, at least one planet gear, at least one planetary pin and at least one bearing. The planet gear is mounted on the planetary pin, in a rotatable manner, by way of the at least one bearing. The arrangement has at least one nut and at least one first locking ring. The planetary pin has at least one shoulder and a thread. The first locking ring is mounted in such a way that the first locking ring can be supported against the shoulder in the axial direction. The nut is screwed onto the thread in such a way that the nut and the locking ring limit the axial play of the bearing, or such that the bearing is tensioned between the nut and the locking ring.

This application is a National Stage completion of PCT/EP2015/063891 filed Jun. 22, 2015 which claims priority from German patent application no. 10 2014 214 295.4 filed Jul. 22, 2014.

### FIELD OF THE INVENTION

The invention relates to an arrangement having a planet carrier, at least one planet gear, at least one planetary pin and at least one bearing as well as a method for mounting of such an arrangement.

### BACKGROUND OF THE INVENTION

Such an arrangement is intended for use in a planet gear set, in particular in a planet gear set of a transmission of a wind turbine.

Planet gear sets for wind turbines are known from the prior art, in which planet gear sets a planetary pin is fixed in a planet carrier in a force-locking manner. Prior to mounting of the planetary pin, the planet carrier is heated so that a shrink connection is created when the planetary pin has been introduced into the planet carrier and the planet carrier then cools down.

The heating of the planet carrier is very energy intensive. This makes the production process expensive. In addition, the mounting process is subject to stringent requirements with regards to timing. This means that the planetary pin can only be mounted in a brief time window between the etching of the planet carrier and the cooling thereof to a determined minimum temperature. Furthermore, the heated planet carrier presents an occupational safety hazard, as the installers are at risk of burns.

### SUMMARY OF THE INVENTION

The invention addresses the problem of designing a planet gear set, in particular for use in the transmission of a wind turbine, in such a way that the disadvantages inherent to the solutions known from the prior art are eliminated. In particular, the mounting should be simplified and the risk of injury to the installers should be reduced. This problem is solved by means of an arrangement as described below.

The arrangement has a planet carrier, at least one planet gear, at least one planetary pin and at least one bearing, preferably two bearings. The planet gear is mounted in a rotatable manner on the planetary pin by means of the bearing.

An inner ring of the bearing is preferably mounted on the planetary pin in such a way that the planetary pin supports the inner ring in the radial direction, in other words, in the direction which extends orthogonal to the rotational axis of the bearing—which is identical to the rotational axis of the planet gear. Radial displacement of the inner ring relative to the planetary pin is thus not possible. The inner ring of the bearing is therefore preferably pushed onto the planetary pin such that the planetary pin extends through the inner ring of the bearing.

The planetary pin is in turn fixed in the planet carrier. This fixation is such that at least every translational displacement of the planetary pin relative to the planet carrier is limited. Limitation of the translational displacements does not, however, mean that no translational displacement is possible. Instead, the fixation via the planet carrier sets limits for the displacement of the planetary pin. A translational displacement of the planetary pin is possible within these limits. The planetary pin therefore has play within the planet carrier.

Furthermore, rotation of the planetary pin relative to the planet carrier about the rotational axis of the planet gear and the bearing can be tolerated. Each rotation of the planetary pin orthogonal thereto is, however, limited by the planet carrier.

The arrangement is provided as part of a planet gear set with a sun gear and a ring gear. The planet gear engages with the sun gear and/or the ring gear.

According to the invention, the arrangement has at least one nut and at least a first locking ring.

The planetary pin is provided with at least one shoulder or step. This shall be understood as being a rotationally-symmetrical surface, which extends at least partially in a radial direction, in other words, not entirely in the axial direction.

A surface extends entirely in the axial direction when it extends entirely parallel to the rotational axis of the planet gear and the bearing.

The shoulder preferably extends radially or entirely in a radial direction. This means that the shoulder is oriented orthogonal to the rotational axis of the planet gear and the bearing.

The at least partially radial orientation of the shoulder allows the first locking ring to be supported against the shoulder in the axial direction. The shoulder then supports the first locking ring against displacement of the first locking ring in a first axial direction relative to the planetary pin. This occurs by means of the creation of a form-locking connection between the ring and the shoulder.

The first locking ring is preferably mounted on the planetary pin. The planetary pin thus extends through the first locking ring so that the planetary pin fixes the first locking ring in a radial direction and limits displacement of the first locking ring in a radial direction relative to the planetary pin.

The planetary pin additionally comprises a thread. This is preferably an external thread. This is designed such that the nut can be screwed onto the thread.

The first locking ring is formed such that it creates a form-locking connection with the inner ring of the bearing and thus limits the displaceability of the inner ring in the first direction. In a corresponding manner, the nut is formed such that it creates a form-locking connection with the inner ring of the bearing and limits the displaceability of the bearing in a second direction extending opposite to the first direction. If the inner ring of the bearing is displaced relative to the planetary pin in the first direction, it thus strikes the first locking ring. If it is displaced relative to the planetary pin in the second direction, it strikes the nut.

Depending on the axial distance between the first locking ring and the nut, the bearing has axial play, with the axial play being limited by the nut and the first locking ring, or is tensioned between the nut and the first locking ring. The selection of the axial distance between the nut and the first locking ring allows the axial play or the pretensioning of the bearing to be adjusted appropriately.

While the position of the first locking ring in the axial direction is defined by the position of the shoulder in the axial direction, the position of the nut in the axial direction is variable. The position of the nut in the axial direction can be adjusted by means of rotation of the nut on the thread. This permits targeted adjustment of the axial play or of the pretensioning of the bearing. The position of the planetary pin relative to the planet carrier is not important.

After the adjustment of the axial play or of the pretensioning of the bearing, the nut must be secured against rotation relative to the planetary pin. For example, the nut can be designed as a slotted nut and secured against rotation by means of a locking plate. It is also possible to screw a screw into the nut, which acts in a force-locking or form-locking manner on the planetary pin. The nut can also be fixed on the planetary pin by means of materially-locking methods such as gluing or welding.

In the simplest version, the first locking ring is a conventional external locking ring, for example, a snap ring or a shaft locking ring. In order to simplify the mounting of the arrangement, the first locking ring is, however, designed in at least two pieces in a preferred further development, wherein the first locking ring comprises a first part and a second part. The first part and the second part are preferably formed such that they each form a part of a ring, in other words, of a rotationally-symmetrical body with a central, rotationally-symmetrical recess.

Both the planetary pin and the planet carrier are formed to fix the first part and the second part in the desired position. According to a further development, the planetary pin has a first groove for this purpose. This groove preferably extends rotationally symmetrically, with the rotational axis of the planet gear and the bearing forming the symmetry axis. The symmetry axis is thus identical to the symmetry axis of the planetary pin.

The first locking ring, in particular the first part and the second part, is inserted into the first groove. The groove thus receives the first locking ring so that the first locking ring extends at least partially in the groove. The groove thus fixes the first locking ring against displacement in a radial direction inwards, i.e., in the first direction, and against displacements in the axial direction.

In particular, one flank of the first groove forms the above-mentioned shoulder of the planetary pin.

In order to hold the first locking ring in its position, the first part and the second part must additionally be secured against displacement relative to the planetary pin in a radial direction outwards. This task is realized by the planet carrier.

Radial displacement outwards refers here to displacement orthogonal to the rotational axis of the planetary pin and the bearing, with the direction of this displacement leading away from the rotational axis. Radial displacement of the first part outwards and radial displacement of the second part outwards would thus lead to the first part and the second part moving away from one another.

In order to prevent this, the planet carrier is preferably designed such that it surrounds the first locking ring. Radial displacement of the first part and of the second part outwards is prevented by means of a form locking between the first ring, or between the first part and the second part, and the planet carrier. A corresponding effective surface of the planet carrier preferably has the form of an inner lateral surface of a straight circular cylinder. Such a form can be realized by means of a bore. This bore is preferably arranged coaxial to a first planetary seat of the planet carrier, with the first planet seat serving to fix the planetary pin in the planet carrier.

Because the axial play or the pretensioning of the bearing is determined by the nut and the first locking ring, the arrangement does not place major demands on the fixation of the planetary pin in the planet carrier. In a preferred further development, it is thus possible to fix the planetary pin in the planet carrier by means of a second locking ring. In particular, fixing the planetary pin in the axial direction is possible by means of the second locking ring.

According to a further development, the planet carrier has a second groove for the insertion of the second locking ring. The second locking ring thus extends, when it has been inserted, at least partially in the second groove. The second locking ring is arranged such that it secures the planetary pin against axial displacement relative to the planet carrier. In particular, the second locking ring can secure the planetary pin against axial displacement in the second direction.

In the case of axial displacement of the planetary pin in the second direction, a form locking occurs between the second locking ring and the planetary pin. The second locking ring thus limits the axial displaceability of the planetary pin relative to the planet carrier. In particular, the second locking ring limits the axial displaceability of the planetary pin relative to the planet carrier in the second direction. The form locking can also be temporary, in other words, the planetary pin can have play in the axial direction relative to the planet carrier.

In a preferred further development, it is also possible to screw the planetary pin to the planet carrier in order to secure the planetary pin against axial displacement relative to the planet carrier. The screwing can be designed in different ways. The planet carrier or the planetary pin can in principle have at least one thread for receiving at least one screw.

In the case of a thread situated in the planetary pin, the planet carrier has a corresponding bore, through which the screw can be fed and screwed into the thread. If the thread is, however, situated in the planet carrier, the planetary pin contains the hole through which the screw can be fed and screwed into the thread. By means of screwing into the thread, the screw is tensioned between the planet carrier and the planetary pin in both cases. This brings about axial fixation of the planetary pin in the planet carrier.

At least one pin seat is usually used for fixing the planetary pin in the planet carrier. This pin seat is preferably formed as a bore, in other words, as a cylindrical recess. The pin seat can have one or two openings.

In one preferred further development, the pin seat receives the nut so that the nut is fixed in the pin seat. A form-locking fixation of the nut in the pin seat which secures it against displacement of the nut relative to the planet carrier in a radial direction is particularly preferred. Because the nut is screwed to the planetary pin, the planetary pin is also fixed by means of the fixation of the nut in the pin seat.

In the case of a fixation of the nut in the pin seat, the planetary pin can be designed such that, together with the screwed on nut, it has the form of a conventional planetary pin. The nut thus requires no additional installation space. The nut is also accessible from outside by means of the pin seat. This permits simple adjustment of the axial play or of the pretensioning of the bearing, even after the planetary pin has been introduced into the planet seat.

Alternatively, the nut can be arranged outside the pin seat in another preferred embodiment. This improves the load-bearing capacity of the planetary pin.

In one method according to the invention for mounting the above-described arrangement, the first locking ring, the bearing and the planet gear are positioned in the planet carrier. The positioning takes place in such a way that the planetary pin, when it is introduced into the planet carrier, can be fed at least partially through the bearing and the first locking ring. This means that at least a part of the planetary pin is fed through the bearing and the first locking ring. Finally, the nut is screwed onto the thread in order to adjust the axial play or the pretensioning of the bearing.

The positioning of the first locking ring and of the bearing and the planet gear in the planet carrier preferably precedes a method step in which the first locking ring, the bearing and the planet gear are introduced into the planet carrier.

In another method step, the planetary pin can be secured against axial displacement. This preferably occurs by means of inserting the second locking ring into the second groove and/or by means of screwing the planetary pin to the planet carrier.

One preferred further development of the method relates to a two-piece first locking ring and a planetary pin with a first groove. The first locking ring is inserted into the first groove once the planetary pin has already been introduced into the planet carrier. In another preferred further development, the nut is subsequently screwed onto the thread.

The individual method steps are preferably realized in the above-mentioned order. However, this order specification is not exhaustive. To the extent that technical conditions allow, the order of the individual method steps can be varied in any way.

### BRIEF DESCRIPTION OF THE DRAWINGS

Exemplary embodiments of the invention are depicted in the figures. The same reference characters identify the same features or functionally identical features. The individual figures show

FIG. 1: a two-piece first locking ring;

FIG. 2A: an arrangement with a fixed nut;

FIG. 2B: a detailed view of the first locking ring;

FIG. 3: an arrangement with a free nut; and

FIGS. 4A-FIG. 4D: individual method steps for the mounting.

### DETAILED DESCRIPTION OF THE PREFERRED EMBODIMENTS

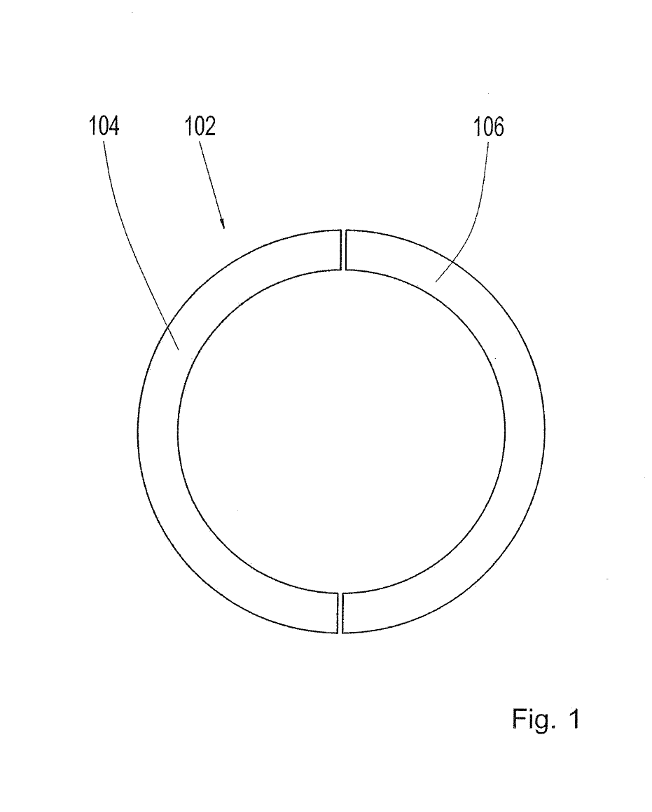

A first locking ring 102 according to FIG. 1 is designed in two pieces. The locking ring 102 consists of a first part 104 and a second part 106. Together, the first part 104 and the second part 106 have the form of a flat hollow cylinder with an annular base area.

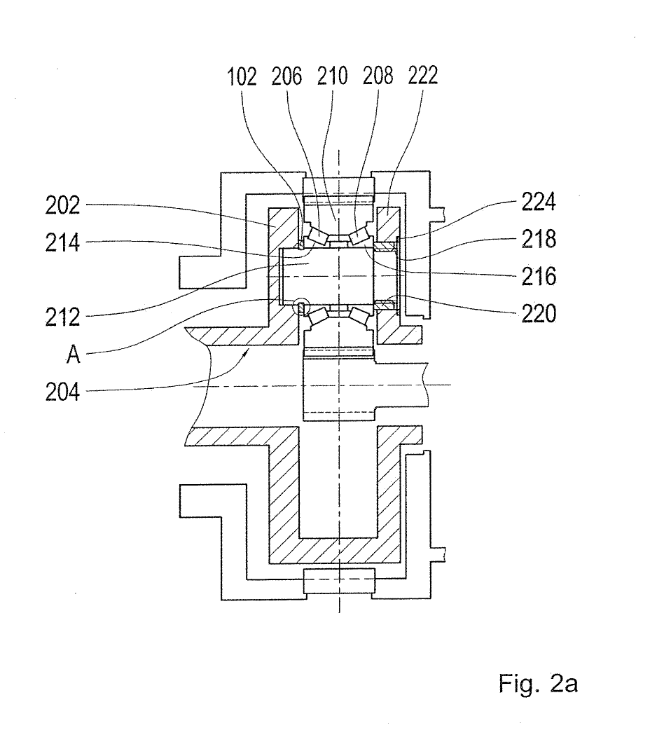

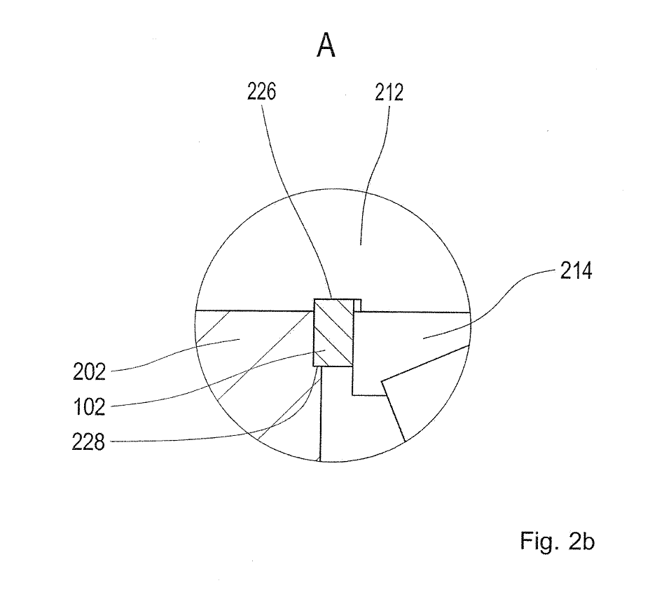

FIG. 2A shows how the first locking ring 102 is installed. The first locking ring 102 is situated between a first wall 202 of a planet carrier 204 and a first planet bearing 206. The first locking ring 102 thus separates the first wall 202 of the planet carrier 204 and the first planet bearing 206. Together with a second planet bearing 208, the first planet bearing 206 serves for rotational mounting of a planet gear 210 on a planetary pin 212. The first planet bearing 206 is, like the second planet bearing 208, designed as a tapered roller bearing. The inner bearing surface of the first planet bearing 206 forms a first inner ring 214. A second inner ring 216 is formed by the inner bearing surface of the second planet bearing 208. On the other hand, the outer bearing surfaces of the first planet bearing 206 and of the second planet bearing 208 are formed by the planet gear 210. The planet gear 210 is, in other words, formed integral with an outer bearing ring of the first bearing 206 and an outer bearing ring of the second planet bearing 208.

The planetary pin 212 has an external thread 218. A nut 220 is screwed thereto.

The first locking ring 102 and the nut 220 are mounted in such a way that they fix the first planet bearing 206, the planet gear 210 and the second planet bearing 208 in the axial direction on the planetary pin 212. Specifically, the first locking ring 102 limits the axial displaceability of the first planet bearing 206 in a first direction. The nut 220 limits the axial displaceability of the second planet bearing 208 in a second direction. The axial displaceability of the first planet bearing 206 in the second direction is limited by the planet gear 210. In a corresponding manner, the planet gear 210 limits the axial displaceability of the second planet bearing 208 in the first direction. This results in the first planet bearing 206 and the second planet bearing 208 having a defined axial play or being pretensioned depending on the position of the nut 220.

In the first wall 202 of the planet carrier 204, the planetary pin 212 is fixed in a conventional manner. A form-locking connection is created between the wall 202 and the planetary pin 212 which prevents radial displacement of the planetary pin 212. If necessary, a shrink connection can also be produced by means of heating of the planet carrier 204.

The planetary pin 212 is not fixed directly in a second wall 222 of the planet carrier 204 however, but by means of the nut 220. A form-locking connection is created between the nut 220 and the second wall 204 which prevents displacement of the nut 220 and thus of the planetary pin 212 in a radial direction. If necessary, a force-locking connection can also be produced between the planet carrier 204 and the nut 220 by means of heating of the planet carrier 204.

Displacement of the planetary pin 212 in the axial direction is prevented by a second locking ring 224, which has been introduced into a groove in the second wall 222 of the planet carrier 204.

A detailed view A is depicted in FIG. 2B. It is possible to see here how the two-piece first locking ring 102 is positioned. A groove 226 in the planetary pin 212 serves to fix the first locking ring 102 in the axial direction. In the depiction of FIG. 2B, the first locking ring 102 is additionally supported on the first wall 202 of the planet carrier 204 in the first direction. If the planetary pin 212 moves in the second direction, this contact is severed. The groove 226 then realizes the support of the first locking ring 102. The movement of the planetary pin 212 would therefore not lead to a change in the axial play of the first planet bearing 206 and of the second planet bearing 208 or to a loss of the pretensioning. The above-described axial fixation of the planetary pin 212 to the second locking ring 224 is therefore adequate and a force-locking fixation of the planetary pin 212 can be dispensed with.

Because the first locking ring 102 is designed in two pieces, it would not remain in the groove 226 without additional means, but would come apart. In order to prevent this, the first wall 202 of the planet carrier 206 is provided with a step 228. This runs around the first locking ring 102 and thus prevents the first part 104 and the second part 106 of the first locking ring 102 from moving apart from each other in the axial direction.

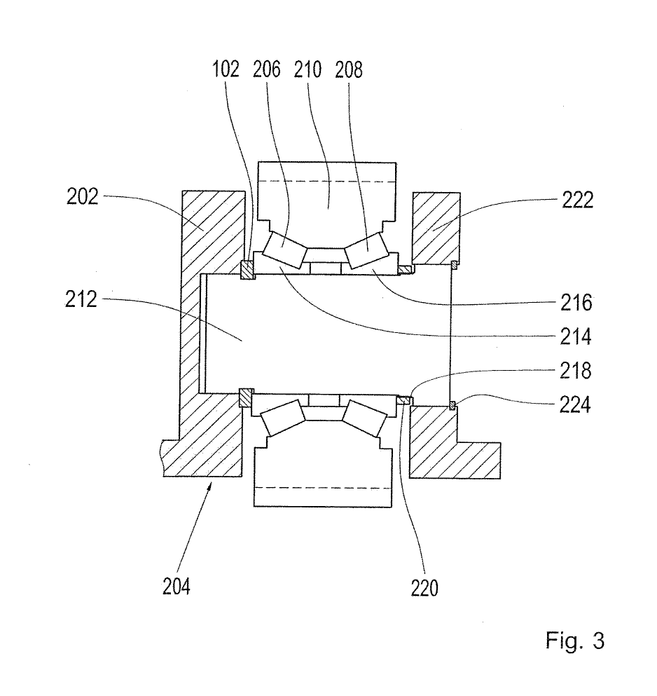

In the variant depicted in FIG. 3, the planetary pin 212 is fixed in a conventional manner in the planet carrier 204. A direct form-locking connection is thus created between the planet carrier 204 and the planetary pin 212. However, the nut 220 is not involved in the fixation of the planetary pin 212 in the planet carrier 204. The nut 220 has no direct contact with the planet carrier 204. The nut is arranged in the axial direction between the inner ring 216 of the second planet bearing 208 and the second wall 222 of the planet carrier 204.

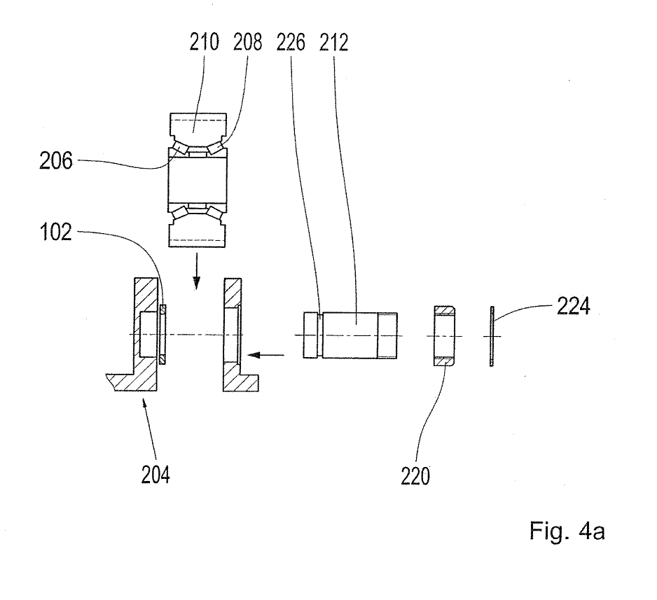

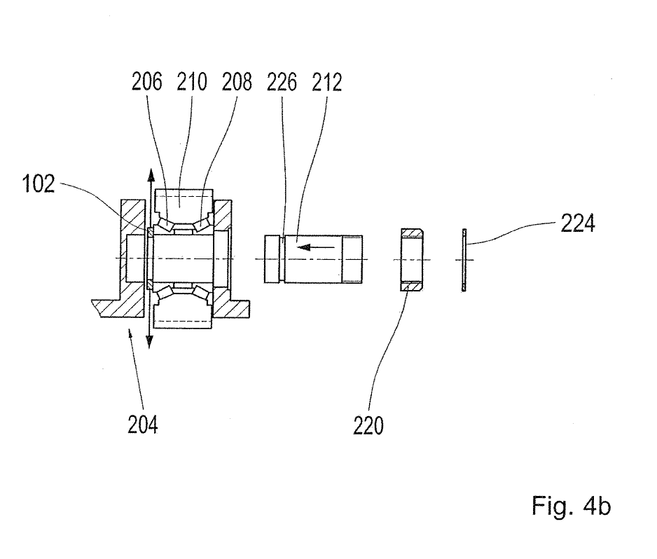

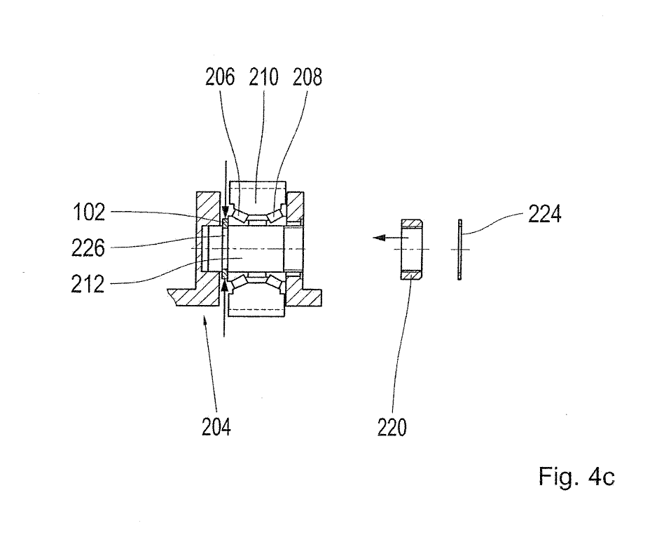

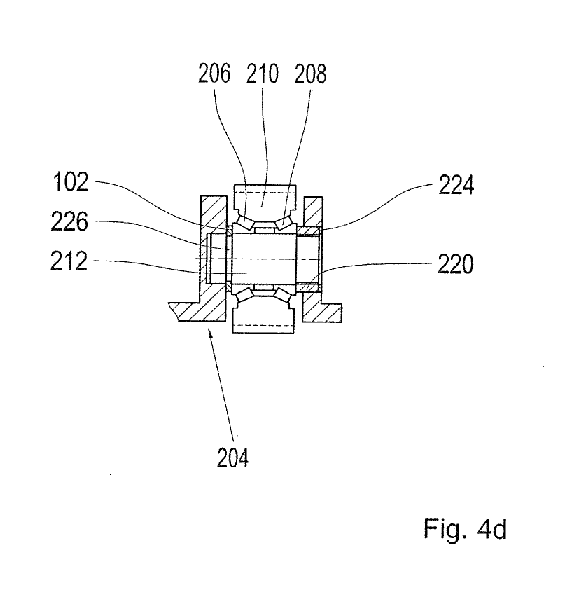

FIGS. 4A to 4D illustrate individual method steps for mounting the planetary pin 212 in the planet carrier 204. Firstly, the first locking ring 102 is introduced into the planet carrier 204 and positioned there concentric to the pin seats of the planet carrier 204. The planet gear 210 already premounted with the first planet bearing 206 and the second planet bearing 208 is likewise introduced into the planet carrier 204 and positioned concentric to the pin seats of the planet carrier 204.

In order to be able to introduce the planetary pin 212 into the planet carrier 204, the two parts 104 and 106 of the first locking ring 102 must firstly be moved radially outwards to some extent. This is shown in FIG. 4B.

In one first step, the planetary pin 212 is pushed into the planet carrier 204 until the groove 226 is at the level of the first locking ring 102. The two parts 104 and 106 of the first locking ring 102 can then be inserted into the groove 226, as depicted in FIG. 4C.

The nut 220 is then screwed onto the planetary pin 212 and the second locking ring 224 is inserted into the planet carrier 204. Finally, the axial fixation of the planetary pin 212 by means of the second locking ring 224 ensures that the step 228 of the planet carrier 204 holds together the two parts 104 and 106 of the first locking ring 102. This is depicted in FIG. 4D.

### REFERENCE CHARACTERS

102 first locking ring
104 first part
106 second part
202 first wall
204 planet carrier
206 first planet bearing
208 second planet bearing
210 planet gear
212 planetary pin
214 first inner ring
216 second inner ring
218 external thread
220 nut
222 second wall
224 second locking ring
226 groove
228 step

1-11. (canceled)

12. An arrangement comprising:
a planet carrier (204),
at least one planet gear (210),
at least one planetary pin (212), and
at least one bearing (206, 208),
the planet gear (210) being mounted in a rotatable manner on the at least one planetary pin (212) by way of the at least one bearing (206, 208), a nut (220) and a first locking ring (102),
the at least one planetary pin (212) having a shoulder and a thread (218),
the first locking ring (102) being mounted such that the first locking ring (102) being supportable, in an axial direction, against the shoulder; and
the nut (220) being screwed onto the thread (218) such that either the nut (220) and the first locking ring (102) limit axial play of the at least one bearing (206, 208), or the at least one bearing (206, 208) being tensioned between the nut (220) and the first locking ring (102).

13. The arrangement according to claim 12, wherein the planetary pin (212) has a first groove (226), the first locking ring (102) is designed as at least two pieces which comprises a first part (104) and a second part (106), the first locking ring (102) is inserted into the first groove (226), and the planet carrier (204) secures the first part (104) and the second part (106) against radial displacement outwards.

14. The arrangement according to claim 12, further having a second locking ring (224), and the planet carrier (204) has a second groove, into which the second locking ring (224) is insertable so that the second locking ring (224) secures the planetary pin (212) against axial displacement.

15. The arrangement according claim 12, wherein the planetary pin (212) is screwed to the planet carrier (204) to secure the planetary pin (212) against axial displacement.

16. The arrangement according to claim 12, wherein the planet carrier (204) has at least one pin seat for fixing the planetary pin (212), and the nut (220) is receivable by the at least one pin seat.

17. The arrangement according to claim 12, wherein the nut (220) is arranged outside of a pin seat.

18. A planetary pin (212) of an arrangement according to claim 12.

19. A planet carrier (204) of an arrangement according to claim 13.

20. A method of mounting an arrangement having a planet carrier (204), at least one planet gear (210), at least one planetary pin (212) and at least one bearing (206, 208), the planet gear (210) is mounted in a rotatable manner on the at least one planetary pin (212) by way of the at least one bearing (206, 208), a nut (220) and a first locking ring (102), the at least one planetary pin (212) has a shoulder and a thread (218), the first locking ring (102) is mounted such that the first locking ring (102) is supportable against the shoulder in an axial direction; and the nut (220) is screwed onto the thread (218) such that either the nut (220) and the first locking ring (102) limit axial play of the at least one bearing (206, 208), or the at least one bearing (206, 208) is tensioned between the nut (220) and the first locking ring (102), the method comprising:
positioning the first locking ring (102) in the planet carrier (204);
positioning the at least one bearing (206, 208) and the at least one planet gear (210) in the planet carrier (204);
introducing the at least one planetary pin (212) into the planet carrier (204) such that the at least one planetary pin (212) being fed at least partially through the at least one bearing (206, 208) and the first locking ring (102); and
screwing the nut (220) onto the thread (218) of the planetary pin (212).

21. The method according to claim 20, further comprising, once the planetary pin (212) has been introduced into the planet carrier (204), inserting the first locking ring (102) into a first groove (226) of the planetary pin.

22. The method according to claim 21, further comprising, once the first locking ring (102) has been inserted into the first groove (226), screwing the nut (220) onto the thread (218).

23. An arrangement comprising:
a planet carrier supporting a planet gear, a planetary pin and at least one bearing;
the planet gear being supported on the planetary pin by the at least one bearing such that the planet gear is rotatable with respect to the planetary pin;
a nut and a first locking ring;
the planetary pin having a shoulder adjacent a first end and a thread adjacent a second opposite end thereof;
the first locking ring being coupled to the planetary pin such that the first locking ring abuts the shoulder of the planetary pin in an axial direction and the nut being screwed onto the thread of the planetary pin such that either:
the nut and the locking ring limiting axial movement of the at least one bearing, or
the at least one bearing being tensioned between the nut and the locking ring.
